(19) United States
(12) Patent Application Publication
(10) Pub. No.: US 2024/0096111 A1
(43) Pub. Date: Mar. 21, 2024

(54) DETERMINING LANE ASSOCIATIONS BASED ON IMAGES

(71) Applicant: QUALCOMM Incorporated, San Diego, CA (US)

(72) Inventors: Shivam AGARWAL, Sunnyvale, CA (US); Avdhut JOSHI, San Marcos, CA (US); Jayakrishnan UNNIKRISHNAN, Bellevue, WA (US); Yoga Y NADARAAJAN, Poway, CA (US); Sree Sesha Aravind VADREVU, San Diego, CA (US); Gautam SACHDEVA, San Diego, CA (US)

(21) Appl. No.: 18/336,860

(22) Filed: Jun. 16, 2023

Related U.S. Application Data
(60) Provisional application No. 63/376,256, filed on Sep. 19, 2022.

(51) Int. Cl. G06V 20/56; B60W 60/00; G06T 7/70

(52) U.S. Cl. CPC G06V 20/588; B60W 60/001; G06T 7/70; B60W 2420/52; G06T 2207/30256

(57) ABSTRACT

Systems and techniques are described herein for determining lane associations of target vehicles. For instance, a method for determining lane associations of target vehicles is provided. The method may include obtaining a two-dimensional bounding box defining a position within an image frame that is associated with a target vehicle; obtaining lane markers defining a position within the image frame that is associated with at least one lane boundary; and associating a lane with the target vehicle based on a relationship between the two-dimensional bounding box and the lane markers.

### CROSS-REFERENCED TO REPLATED APPLICATIONS

This application claims the benefit of U.S. Provisional Application No. 63/376,256, filed on Sep. 19, 2022, which is incorporated herein by reference in its entirety.

### TECHNICAL FIELD

The present disclosure generally relates to determining lane associations based on images. For example, aspects of the present disclosure include systems and techniques for obtaining images of target vehicles and determining lane associations for the target vehicles based on the images.

### BACKGROUND

Object detection can be used to identify objects (e.g., from a digital image or a video frame of a video clip). Object tracking can be used to track a detected object over time. Object detection and tracking can be used in different fields, including autonomous driving, video analytics, security systems, robotics, aviation, among many others. In some fields, a tracking object can determine positions of target objects in an environment so that the tracking object can accurately navigate through the environment (e.g., to make accurate motion planning and trajectory planning decisions).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope as sociated with any particular aspect. Accordingly, the following summary presents certain concepts relating to one or more aspects relating to the mechanisms disclosed herein in a simplified form to precede the detailed description presented below.

Systems and techniques are described herein for determining lane associations of target vehicles. According to at least one example, an apparatus for determining lane associations of target vehicles is provided. The apparatus includes a memory and one or more processors coupled to the memory. The one or more processors are configured to: obtain a two-dimensional bounding box defining a position within an image frame that is associated with a target vehicle; obtain lane markers defining a position within the image frame that is associated with at least one lane boundary; and associate a lane with the target vehicle based on a relationship between the two-dimensional bounding box and the lane markers.

In another example, a method for determining lane associations of target vehicles is provided. The method includes: obtaining a two-dimensional bounding box defining a position within an image frame that is associated with a target vehicle; obtaining lane markers defining a position within the image frame that is associated with at least one lane boundary; and associating a lane with the target vehicle based on a relationship between the two-dimensional bounding box and the lane markers.

In another example, a non-transitory computer-readable medium is provided that has stored thereon instructions that, when executed by at least one processor, cause the at least one processor to: obtain a two-dimensional bounding box defining a position within an image frame that is associated with a target vehicle; obtain lane markers defining a position within the image frame that is associated with at least one lane boundary; and associate a lane with the target vehicle based on a relationship between the two-dimensional bounding box and the lane markers.

As another example, an apparatus is provided. The apparatus includes means for obtaining a two-dimensional bounding box defining a position within an image frame that is associated with a target vehicle; means for obtaining lane markers defining a position within the image frame that is associated with at least one lane boundary; and means for associating a lane with the target vehicle based on a relationship between the two-dimensional bounding box and the lane markers.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is an diagram illustrating vehicles driving on a road, including a tracking vehicle which may track others of the vehicles, according to various aspects of the present disclosure;

FIG. 2A is a representation of an example image captured by a camera of a tracking vehicle;

FIG. 2B is a diagram illustrating a bird's eye view of an environment of the tracking vehicle;

FIG. 3 is a diagram illustrating example data points arranged in an image frame, according to various aspects of the present disclosure;

FIG. 4 is another diagram illustrating example data points arranged in an image frame, according to various aspects of the present disclosure;

FIG. 5 is another diagram illustrating example data points arranged in an image frame, according to various aspects of the present disclosure;

FIG. 6 is another diagram illustrating example data points arranged in an image frame, according to various aspects of the present disclosure;

FIG. 7 is another diagram illustrating example data points arranged in an image frame, according to various aspects of the present disclosure;

FIG. 8 is a diagram illustrating example data points arranged in an image frame overlaid onto a representation of an image corresponding to the image frame, according to various aspects of the present disclosure;

FIG. 9 is a flow diagram illustrating example process for determining lane associations of target vehicles, in accordance with aspects of the present disclosure;

FIG. 10 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Object detection and tracking can be used to identify an object and track the object over time. For example, an image of an object can be obtained, and object detection can be performed on the image to detect one or more objects in the image. In some cases, the detected object can be classified into a category of object and a bounding box can be generated to identify a position of the object in the image. Various types of systems can be used for object detection, including neural network-based object detectors.

Object detection and tracking can be used in autonomous driving systems, video analytics, security systems, robotics systems, aviation systems, among others systems. In such systems, an object (referred to as a tracking object) can track other objects (referred to as target objects) in an environment and determine positions and sizes of the other objects. Determining the locations, orientations, sizes, and/or other characteristics of target objects in the environment allows the tracking object to accurately navigate through the environment by making intelligent motion planning and trajectory planning decisions. However, it can be difficult to accurately identify such characteristics of the target object.

One example of a field where a tracking object needs to be able to determine characteristics (e.g., location, orientation, size, etc.) of target objects is autonomous or semi-autonomous driving by autonomous/semi-autonomous driving systems (e.g., of autonomous vehicles). In such cases, a tracking object can be a vehicle and a target object can be another vehicle, a lane on a road, an object on a road (e.g., a cone, a median, etc.), and/or other object. An important goal of autonomous driving systems is the ability of an autonomous vehicle to detect and track other vehicles and objects around the autonomous vehicle. This can become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain at the in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles full autonomous, self-driving vehicles that operate autonomously in all conditions. A human operator is not needed for the vehicle to take any action.

Various aspects of the application will be described with respect to the figures below.

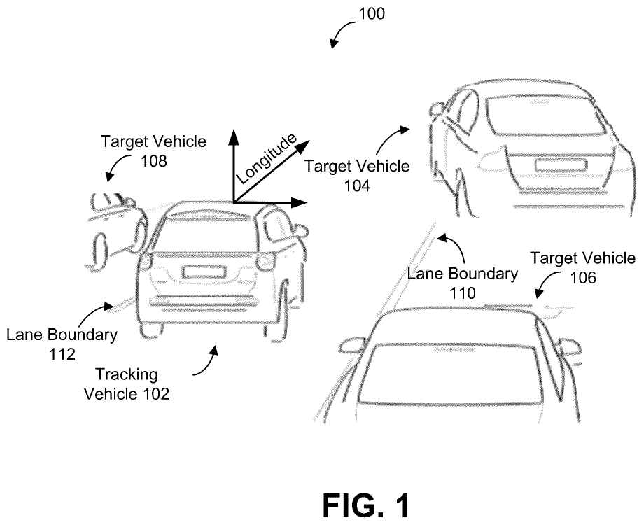

FIG. 1 is an diagram illustrating vehicles driving on a road, including a tracking vehicle 102 which may track others of the vehicles, according to various aspects of the present disclosure. The vehicles include a tracking vehicle 102, a target vehicle 104, a target vehicle 106, and a target vehicle 108. The road is divided into lanes marked by lane boundary 110 and lane boundary 112 (e.g., among others not illustrated in FIG. 1). Tracking vehicle 102 may be an autonomous or semi-autonomous vehicle operating at any autonomy level. Tracking vehicle 102 can track the target vehicle 104, target vehicle 106, target vehicle 108, lane boundary 110 and/or lane boundary 112 in order to navigate in 100. For example, tracking vehicle 102 can track target vehicle 104 and/or one or more lanes (or other road objects) in which tracking vehicle 102 is driving to determine when to slow down, speed up, change lanes, and/or perform some other function. While tracking vehicle 102 is referred to as a tracking vehicle 102 and the target vehicle 104, target vehicle 106, and target vehicle 108 are referred to as target vehicles with respect to FIG. 1, the target vehicle 104, target vehicle 106, and target vehicle 108 can also be referred to as tracking vehicles if and when they are tracking other vehicles, in which the other vehicles become target vehicles.

In may be useful to associate target vehicles with lanes. For example, to track target vehicle 104, target vehicle 106, and/or target vehicle 108 and/or to plan movements, tracking vehicle 102 may associate each of target vehicle 104, target vehicle 106, and target vehicle 108 with a respective lane. For example, it may be useful for tracking vehicle 102 to assume that target vehicle 106 and/or target vehicle 108 are generally going to remain in their respective lanes. Further, it may be useful to note that target vehicle 104 is entering the lane of tracking vehicle 102.

According to some techniques, in order to associated target vehicles with lanes, tracking vehicle 102 may identify locations of target vehicles and identify locations of lanes. Tracking vehicle 102 may track target vehicle 104, target vehicle 106, and/or target vehicle 108 using perception techniques. Examples of such perception techniques include image-based techniques based on images captured by cameras of tracking vehicle 102, radio detection and ranging (RADAR)-based techniques, and light detection and ranging (LIDAR)-based techniques.

In some cases, tracking vehicle 102 may track target vehicles using multiple independent sensor modalities. For example, tracking vehicle 102 may track target vehicles using images from a camera. Some convolutional neural network (CNN)-based tracking techniques work well in the pixel domain (e.g., based on pixel data of image frames). Such techniques allow for high fidelity in comprehending the scene. Such techniques may further allow for object detection, feature extraction, scene segmentation, and/or context detection, among other things. However, image-based techniques may be poor at three-dimensional (3D) localization of objects.

Further, tracking vehicle 102 may use RADAR-based tracking techniques. Such techniques may provide sparse low-fidelity data which may allow for good 3D localization. Further RADAR-based tracking techniques may allow for doppler-based velocity estimation. However, RADAR-based techniques may be poor at object classification.

Tracking vehicle 102 may fuse image-based techniques and/or data with RADAR-based techniques and/or data for pose estimation and/or dynamics estimation. Fusing the techniques may allow tracking vehicle 102 to use the strengths of each technique. Fusing the techniques may include incorporating geometric sensor modeling for each sensor modality.

According to some techniques, tracking vehicle 102 may determine the location of lanes using perception techniques. Perception-based lane location may suffer from longitudinal estimation errors. In the present disclosure, the term “longitude,” and like terms, may refer to a direction extending in front of a tracking vehicle. The term longitudinal errors may refer to errors in the longitudinal axis, in other words errors in determining how distant a point or object (e.g., a lane boundary) in front of the tracking vehicle is from the tracking vehicle. Longitudinal errors may result from improperly relying on a flat-plane assumption, defects or limitations in cameras or sensors, and/or incorrect associations in bird's eye view (BEV) space.

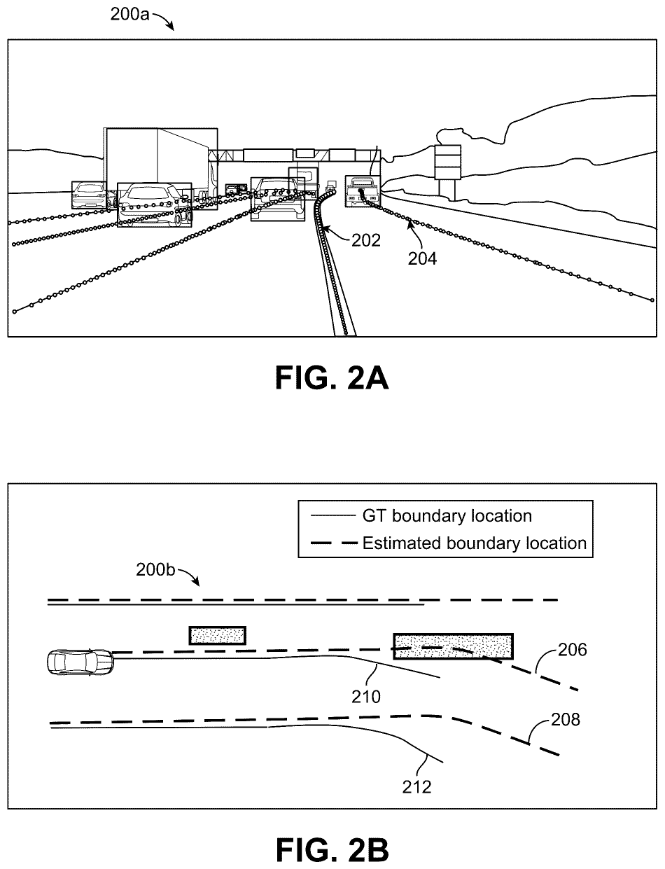

FIG. 2A and FIG. 2B illustrate such issues with perception-based lane-location techniques. As an example, FIG. 2A is a representation of an image 200a captured by a camera of a tracking vehicle (e.g., tracking vehicle 102 of FIG. 1). In image 200a, lane boundary 202 and lane boundary 204 shift to the right as the lanes get farther (in the longitudinal direction) from the tracking vehicle. FIG. 2B is a diagram illustrating a bird's eye view 200b of the environment. Bird's eye view 200b includes estimated lane boundary 206 and estimated lane boundary 208, which may be estimated using perception-based lane-location techniques. Bird's eye view 200b also includes actual lane boundary 210 and actual lane boundary 212, which may be actual lane boundaries. Estimated lane boundary 206 and estimated lane boundary 208 deviate from actual lane boundary 210 and actual lane boundary 212. The deviation is an example of longitudinal errors of a perception-based lane location technique.

Returning to FIG. 1, according to some techniques, tracking vehicle 102 may determine the location of lanes using a map (e.g., a high-definition map of 100 including lane boundaries). Maps can be inaccurate, out of date, or unavailable in some locations. Thus, lane associations based on perceptions of target vehicles and perceptions of lanes and/or based on maps can be inaccurate.

Systems, apparatuses, methods (also referred to as processes), and computer-readable media (collectively referred to herein as “systems and techniques”) are described herein for determining lane associations for target vehicles based on images captured at a tracking vehicle. The systems and techniques described herein may obtain a two-dimensional bounding box defining a position within an image frame that is associated with a target vehicle. The systems and techniques may also obtain lane markers defining a position within the image frame that is associated with at least one lane boundary. The systems and techniques may then associate a lane with the target vehicle based on a relationship between the two-dimensional bounding box and the lane markers in the image frame.

The systems and techniques may provide a more robust way of associating objects to their respective lanes using images. The systems and techniques may be more accurate because the systems and techniques may not rely on maps (which may be inaccurate or unavailable). Further, the systems and techniques may avoid improperly relying on a flat-plane assumption and/or incorrect associations in bird's eye view (BEV) space because the systems and techniques may determine lane associations based on relationships in the image frame and not based on a three-dimensional models of the target vehicles and/or of the road.

The systems and techniques can satisfy various requirements or goals, including providing lane assignment for drive-by-perception use cases, being robust to errors in online map generation, being robust to errors in high-definition (HD)-Maps, handling complicated lane geometries, performing splits and/or merges, any combination thereof, and/or others.

One or more inputs can be used by the systems and techniques in performing operations according to aspects described herein. For example, camera inputs can include two-dimensional (2D) pixel level camera inputs, bounding box for objects with classification, keypoints for objects, 2D lane markers with semantic assignment, among others.

Outputs of the systems and techniques can include lane associations and/or relative lane assignment with respect to a lane in which a tracking vehicle (also referred to as an ego vehicle) is located. For example, the tracking vehicle may be in a lane labeled 0, lanes to the left of lane of the lane of the tracking vehicle may be labeled [−1, −2 . . . ], and lanes to the right of lane of the lane of the tracking vehicle may be labeled [1, 2 . . . ].

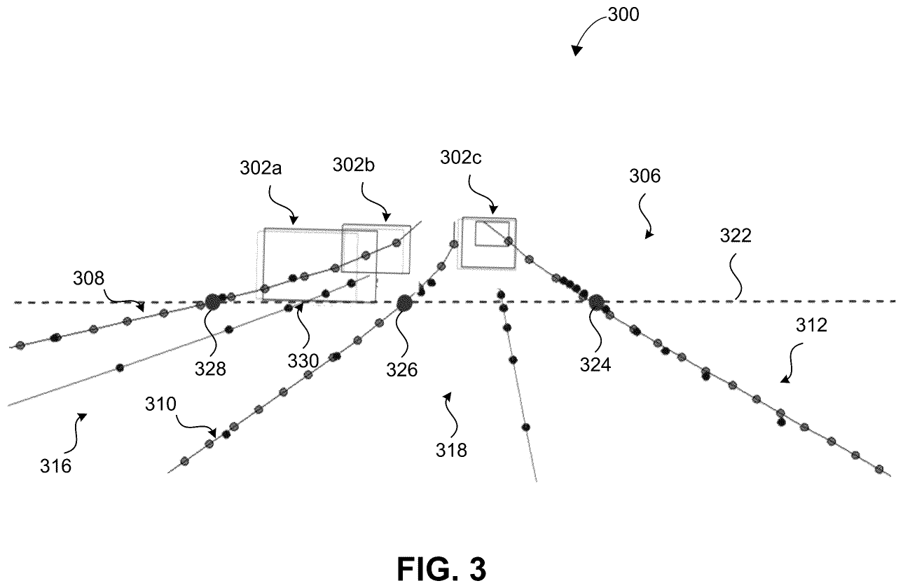

FIG. 3 is a diagram illustrating example data points arranged in an image frame 300, according to various aspects of the present disclosure. The systems and techniques may use the data points to determine lane associations of target vehicles.

The data points illustrated in image frame 300 include bounding boxes 302 (including bounding box 302a, bounding box 302b, and bounding box 302c). Each of bounding boxes 302 may define a position within image frame 300 that is associated with a respective target vehicle. Bounding boxes 302 may be two-dimensional. In some cases, bounding boxes 302 may be axis-aligned, in other words, at least a bottom edge of each of bounding boxes 302 may align with a bottom edge of image frame 300. Bounding boxes 302 may be determined using any suitable object-detection or object-tracking technique based on an image corresponding to image frame 300. More detail regarding how bounding box 302a may be defined is provided below.

Additionally, the data points illustrated in image frame 300 include lane markers 306. Lane markers 306 may define positions of lane boundary 308, positions of lane boundary 310, and positions of lane boundary 312 in image frame 300. Lane markers 306 may be two-dimensional. Lane boundary 310 and lane boundary 312 may be a pair and may define a lane 318, which may be a lane of the tracking vehicle, and which therefore may be labeled lane 0. Lane boundary 308 and lane boundary 310 may be a pair and may define a lane 316, which may be to the left of the lane of the tracking vehicle and may therefore be labelled lane −1. Lane markers 306 may be determined using any suitable object-detection or object-tracking technique based on an image corresponding to image frame 300.

The systems and techniques may obtain bounding boxes 302, lane markers 306 and may associate a lane with target vehicles based thereon. For example, the systems and techniques may associate lane 316 with a target vehicle on which bounding box 302a is based based on a relationship between bounding box 302a and lane boundary 308 and lane boundary 310. As another example, the systems and techniques may associate lane 318 with a target vehicle on which bounding box 302c is based based on a relationship between bounding box 302c and lane boundary 310 and lane boundary 312.

FIG. 3, and the accompanying description describe a first approach to determining lane associations. According to the first approach, bounding boxes 302 may be based on three-dimensional bounding boxes. For example, an object-detection or object-tracking technique may be used to define three-dimensional bounding boxes based on images of target vehicles. The three-dimensional bounding boxes may be tracked through multiple images. Image frame 300 may be based on one of multiple images in which the three-dimensional bounding boxes are detected and/or tracked. The three-dimensional bounding boxes may be projected into image frame 300 and the two-dimensional projections may define bounding boxes 302.

After defining bounding boxes 302, each of bounding boxes 302 may be compared with lane boundaries to determine the association between the lanes and the target vehicles based on the respective bounding boxes 302. For example, a line 322, which is aligned with a bottom edge of image frame 300, may be defined based on a bottom edge of bounding box 302a. Point 324, point 326, and point 328, at which line 322 intersects with the lane boundary 312, lane boundary 310, and lane boundary 308 respectively, may be identified. Lane 316 may be associated with the target vehicle on which bounding box 302a is based based on a relationship between bounding box 302a and point 326 and point 328. For example, lane 316 may be associated with the target vehicle on which bounding box 302a is based based on a center point 330 of a bottom edge of bounding box 302a being between point 328 and point 326.

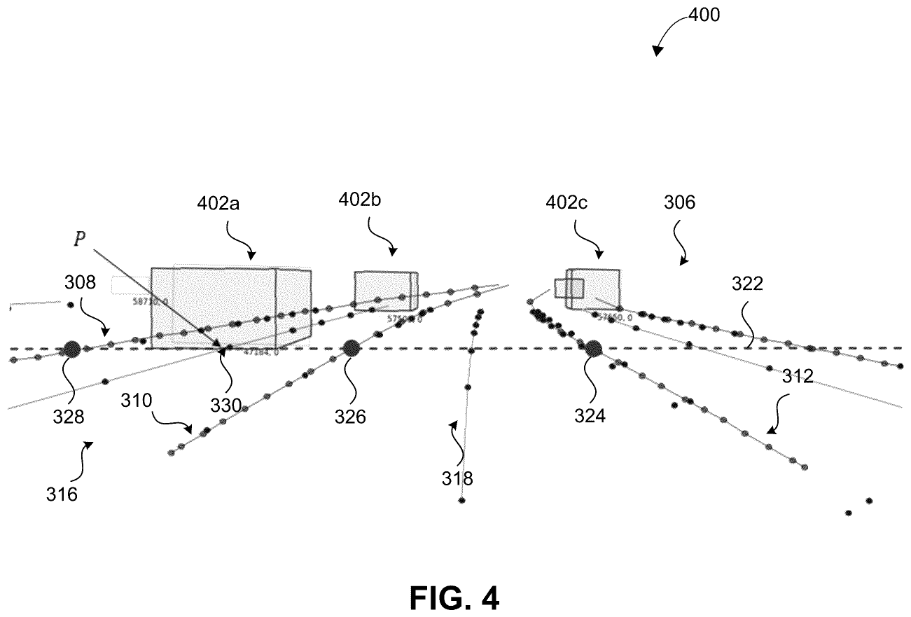

FIG. 4 is a diagram illustrating example data points arranged in an image frame 400, according to various aspects of the present disclosure. FIG. 4, and the accompanying description describe a second approach to determining lane associations.

According to the second approach, bounding boxes (including bounding box 402a, bounding box 402b, and bounding box 402c, collectively referred to as bounding boxes 402) may be defined based on a back plane of a three-dimensional bounding box. For example, an object-detection or object-tracking technique may be used to define three-dimensional bounding boxes based on images of target vehicles. The three-dimensional bounding boxes may be tracked through multiple images. Image frame 400 may be based on one of multiple images in which the three-dimensional bounding boxes are detected and/or tracked. A back plane of each of the three-dimensional bounding boxes may define bounding boxes 402.

After defining bounding boxes 402, each of bounding boxes 402 may be compared with lane boundaries to determine the association between the lanes and the target vehicles based on the respective bounding boxes 402. For example, a line 322, which is aligned with a bottom edge of image frame 400, may be defined based on a bottom edge of bounding box 402a. Point 324, point 326, and point 328, at which line 322 intersects with the lane boundary 312, lane boundary 310, and lane boundary 308 respectively, may be identified. Lane 316 may be associated with the target vehicle on which bounding box 402a is based based on a relationship between bounding box 402a and point 326 and point 328. For example, lane 316 may be associated with the target vehicle on which bounding box 402a is based based on a center point 330 of a bottom edge of bounding box 402a being between point 328 and point 326.

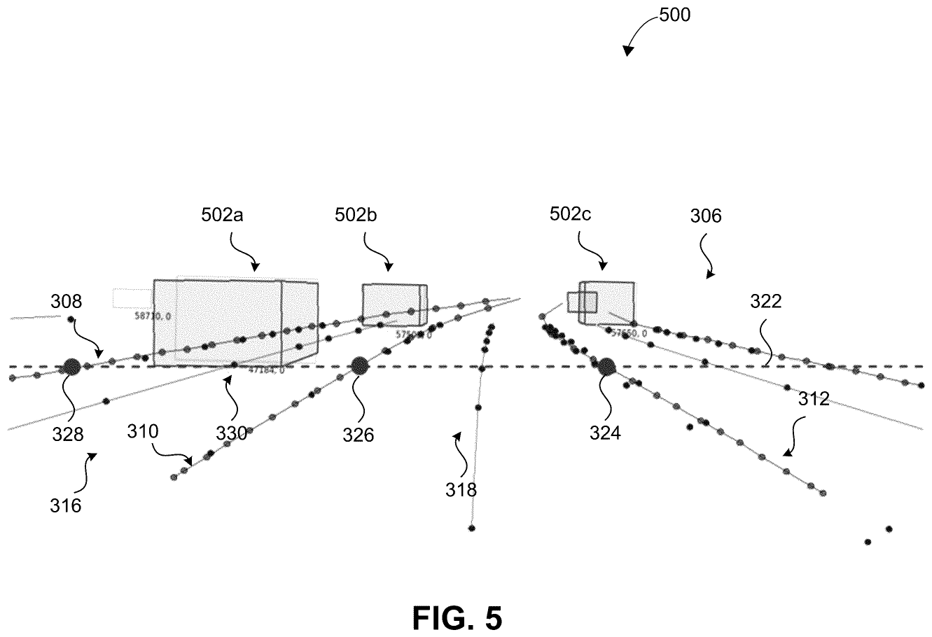

FIG. 5 is a diagram illustrating example data points arranged in an image frame 500, according to various aspects of the present disclosure. FIG. 5, and the accompanying description describe a third approach to determining lane associations.

According to the third approach, bounding boxes (including bounding box 502a, bounding box 502b, and bounding box 502c, collectively referred to as bounding boxes 502) may be defined based on a center plane of a three-dimensional bounding box. For example, an object-detection or object-tracking technique may be used to define three-dimensional bounding boxes based on images of target vehicles. The three-dimensional bounding boxes may be tracked through multiple images. Image frame 500 may be based on one of multiple images in which the three-dimensional bounding boxes are detected and/or tracked. A center plane of each of the three-dimensional bounding boxes may define bounding boxes 502. The center plane may be defined as a plane passing through a center point of a three-dimensional bounding box and parallel to the image frame.

After defining bounding boxes 502, each of bounding boxes 502 may be compared with lane boundaries to determine the association between the lanes and the target vehicles based on the respective bounding boxes 502. For example, a line 322, which is aligned with a bottom edge of image frame 500, may be defined based on a bottom edge of bounding box 502a. Point 324, point 326, and point 328, at which line 322 intersects with the lane boundary 312, lane boundary 310, and lane boundary 308 respectively, may be identified. Lane 316 may be associated with the target vehicle on which bounding box 502a is based based on a relationship between bounding box 502a and point 326 and point 328. For example, lane 316 may be associated with the target vehicle on which bounding box 502a is based based on a center point 330 of a bottom edge of bounding box 502a being between point 328 and point 326.

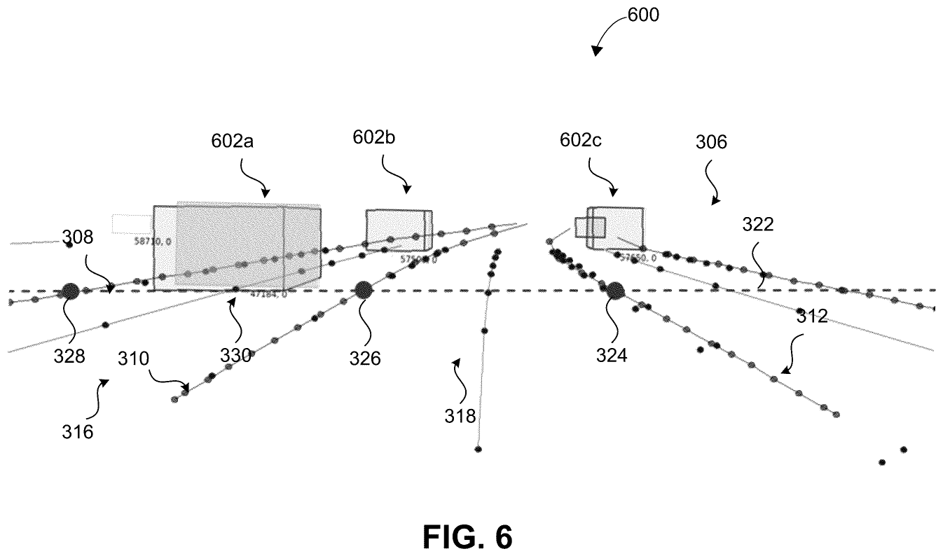

FIG. 6 is a diagram illustrating example data points arranged in an image frame 600, according to various aspects of the present disclosure. FIG. 6, and the accompanying description describe a fourth approach to determining lane associations.

According to the fourth approach, bounding boxes (including bounding box 602a, bounding box 602b, and bounding box 602c, collectively referred to as bounding boxes 602) may be determined as a step in an object-detection or object-tracking technique. The object-detection or object-tracking technique may identify two-dimensional bounding boxes as a step toward defining three-dimensional bounding boxes. In such cases, the two-dimensional bounding boxes may be used as bounding boxes 602 in determining lane associations with or without the use of the three-dimensional bounding boxes for the determining lane associations.

After defining bounding boxes 602, each of bounding boxes 602 may be compared with lane boundaries to determine the association between the lanes and the target vehicles based on the respective bounding boxes 602. For example, a line 322, which is aligned with a bottom edge of image frame 600, may be defined based on a bottom edge of bounding box 602a. Point 324, point 326, and point 328, at which line 322 intersects with the lane boundary 312, lane boundary 310, and lane boundary 308 respectively, may be identified. Lane 316 may be associated with the target vehicle on which bounding box 602a is based based on a relationship between bounding box 602a and point 326 and point 328. For example, lane 316 may be associated with the target vehicle on which bounding box 602a is based based on a center point 330 of a bottom edge of bounding box 602a being between point 328 and point 326.

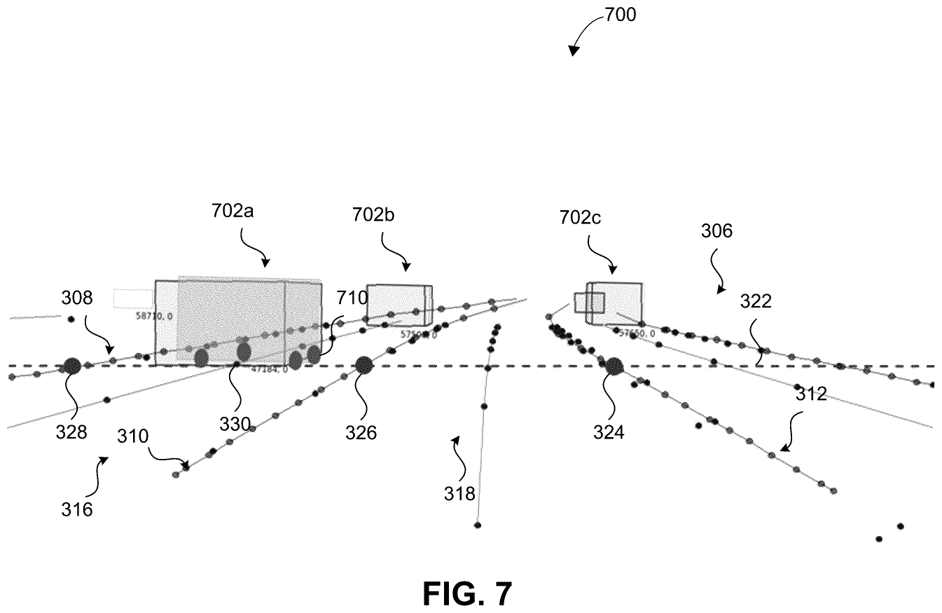

FIG. 7 is a diagram illustrating example data points arranged in an image frame 700, according to various aspects of the present disclosure. FIG. 7, and the accompanying description describe a fifth approach to determining lane associations.

According to the fifth approach, bounding boxes (including bounding box 702a, bounding box 702b, and bounding box 702c, collectively referred to as bounding boxes 702) may be determined as a step in an object-detection or object-tracking technique or based on a three-dimensional bounding box determined through an object-detection or object-tracking technique. In some cases, the object-detection or object-tracking technique may identify two-dimensional bounding boxes as a step toward defining three-dimensional bounding boxes. In such cases, the two-dimensional bounding boxes may be used as bounding boxes 602 for determining lane associations for determining lane associations with or without the use of the three-dimensional bounding boxes for determining the lane associations. In other cases, the three-dimensional bounding boxes may be projected onto image frame 700 and the projection may be used as bounding boxes 702. In other cases, a plane of the three-dimensional bounding boxes may be selected and used as bounding boxes 702.

Additionally, or alternatively, keypoints 710 of the target vehicles may be determined. Keypoints 710 may be determined as part of an object-detection or object tracking technique. Additionally, or alternatively, keypoints 710 may be determined separately. Keypoints 710 may be related to bounding boxes 702. For example, keypoints 710 may be within bounding boxes 702. As an example, keypoints 710 may be based on wheels of the target vehicles.

According to the fifth approach, one or more of keypoints 710 may be compared with lane boundaries to determine the association between the lanes and the target vehicles. For example, a line 322 aligned with a bottom edge of image frame 700 may be defined based on bounding box 702a and/or based on keypoints 710 of bounding box 702a. Point 324, point 326, and point 328, at which line 322 intersects with the lane boundary 308, lane boundary 310, and lane boundary 312 respectively, may be identified. Lane 316 may be associated with the target vehicle on which bounding box 702a is based based on a relationship between keypoints 710 and point 326 and point 328. For example, lane 316 may be associated with a target vehicle on which bounding box 702a is based based on one or more of keypoints 710 of bounding box 702a being between point 328 and point 326.

In some cases, a closest keypoint 710 of a group of keypoints 710 associated with a bounding box may be identified and the lane may be associated with the target vehicle based on the closest keypoint 710. For example, object tracking may determine 3D locations of keypoints 710. Based on the 3D locations, a laterally or a longitudinally closest key point may be determined. The laterally or the longitudinally closest keypoint may be used for lane association Additionally, or alternatively, the closest keypoint 710 may be based on a proximity, in image frame 700, to a vertical center line through the middle of image frame 700. Additionally, or alternatively, a keypoint closest to the bottom edge of image frame 700 and closest to the vertical center line may identified as the closest keypoint.

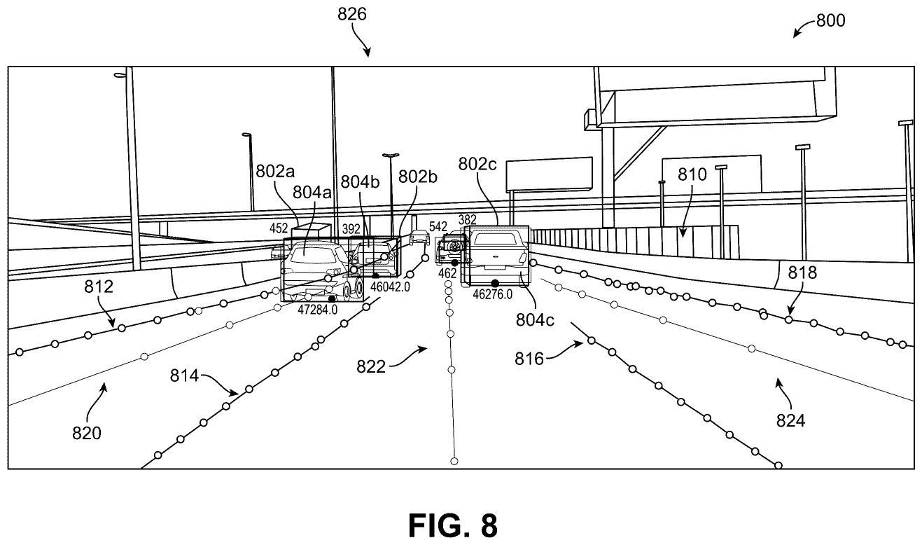

FIG. 8 is a diagram illustrating example data points arranged in an image frame 800 overlaid onto a representation of an image 826 corresponding to the image frame 800, according to various aspects of the present disclosure.

Three-dimensional bounding boxes (including three-dimensional bounding box 802a, three-dimensional bounding box 802b, and three-dimensional bounding box 802c, collectively referred to as three-dimensional bounding boxes 802) are illustrated in FIG. 8. Three-dimensional bounding boxes 802 may be determined using an object-detection and/or object-tracking technique. The three-dimensional bounding boxes 802 may be axis aligned, for example, a bottom edge of each of three-dimensional bounding boxes 802 may be aligned with a bottom edge of image frame 800. Each of three-dimensional bounding boxes 802 may be based on a respective one of target vehicles 804 (including target vehicle 804a, target vehicle 804b, and target vehicle 804c). For example, three-dimensional bounding box 802a may be based on target vehicle 804a, three-dimensional bounding box 802b may be based on target vehicle 804b, and three-dimensional bounding box 802c may be based on target vehicle 804c.

The data points illustrated in image frame 800 include lane markers 810 including lane boundary 812, lane boundary 814, lane boundary 816, and lane boundary 818. Lane markers 810 may define positions of lane boundary 812, lane boundary 814, lane boundary 816, and lane boundary 818 in image frame 800. Lane markers 810 may be determined using any suitable object-detection and/or object tracking technique. Lane boundary 812 and lane boundary 814 may be a pair of lane boundaries that may be associated with and define lane 820. Lane boundary 814 and lane boundary 816 may be a pair of lane boundaries that may be associated with and define lane 822. Lane boundary 816 and lane boundary 818 may be a pair of lane boundaries that may be associated with and define lane 824. Lane markers 810 may be received with, or determined with, lane labels. For example, lane 822 may be labeled 0 because it may be the lane of the tracking vehicle which captured the image 826. Lane 820 may be labeled lane −1 because it is left of lane 0 and lane 824 may be labeled lane 1 because it is right of lane 0.

As described previously, the systems and techniques may determine lane associations for target vehicles 804 based on two-dimensional bounding boxes that are based on three-dimensional bounding boxes 802. For example, according to various approaches, a two-dimensional bounding box (not illustrated in FIG. 8) may be determined based on three-dimensional bounding box 802a. A point of the two-dimensional bounding box (e.g., a center point of a bottom line of the two-dimensional bounding box) may be identified. Lane 820 may be associated with three-dimensional bounding box 802a based on the relationship between the point and lane boundary 812 and lane boundary 814.

Further, FIG. 8 illustrates an example of an additional challenge to lane association. In particular, in image 826, lane boundary 816 ends below target vehicle 804c in image frame 800. In image 826, it may be unclear to which lane target vehicle 804c should be associated because three-dimensional bounding box 802c is not between a pair of lane boundaries. Lane boundary 816 may cease because visual lane dividers (e.g., dashed lines in image 826) have ceased. Alternatively, lane boundary 816 may cease because past the point where lane boundary 816 cease, lane 822 and lane 824 merge.

The systems and techniques may determine a lane association for target vehicle 804c based on lane boundary 814 and/or lane boundary 818 in instances in which lane boundary 816 (one of a pair of lane boundaries defining lane 822 and lane 824) is missing. For example, the systems and techniques may determine a distance between lane boundary 814 and/or lane boundary 818 and a two-dimensional bounding box based on three-dimensional bounding box 802c. The systems and techniques may determine whether target vehicle 804c is associated with lane 822 based on the distance between the two-dimensional bounding box based on three-dimensional bounding box 802c and lane boundary 814. As an example, the systems and techniques may determine to associate target vehicle 804c with lane 822 if any point of the two-dimensional bounding box (e.g., a center point or a leftmost point of a bottom line of the two-dimensional bounding box) based on three-dimensional bounding box 802c is less than a lane width (e.g., 3.7 meters) from lane boundary 814. Additionally, or alternatively, the systems and techniques may determine whether target vehicle 804c is associated with lane 824 based on the distance between the two-dimensional bounding box based on three-dimensional bounding box 802c and lane boundary 818.

As an example, the systems and techniques may determine a point p, of a two-dimensional bounding box based on a three-dimensional bounding box. Point p may be defined as p=[pₓ,p_{y},p_{z}], where pₓ, p_{y}, and p_{z}, describe a three-dimensional location of the point in the camera frame (e.g., in an xyz camera coordinate frame where x describes right and left, y describes up and down, and z describes forward). The systems and techniques may determine whether point p belongs to a lane l (e.g., the lane of the tracking vehicle) based on distances between point p and lane boundaries. An association rule can be defined as follows:

If both lane boundaries are detected:

True iff lₓ^{left}≤proj(p)x≤lₓ^{right}
where lₓ^{left} describes the pixel location of left lane boundary of a pair of lane boundaries of the lane l at a y that corresponds to p_{y}; where proj (p) is a function that takes a point p in the camera frame and return point in pixel domain; and where lₓ^{right} describes the pixel location of right lane boundary of the pair of lane boundaries of the lane l at a y that corresponds to p_{y}.

For example, where both lane boundaries of a pair are present, a target vehicle is associated with the lane l when a point p (e.g., a center point of a bottom line) of a two-dimensional bounding box which is based on the target vehicle is between the pair of lane boundaries of the lane l.

The association rule can be further defined as follows:

If only one lane boundary of a pair of lane boundaries is detected:

distance from boundary,d=proj(p)ₓ−lₓ^{left} or lₓ^{right}−Proj(p)ₓ

For example, a distance d is defined between a lane boundary and a point p (e.g., a center point of a bottom line) of a two-dimensional bounding box which is based on the target vehicle.

$$True iff d \leq {f}_{χ} * \frac{{l}_{w}}{P z}$$

For example, the target vehicle is associated with the lane l (e.g., lane 0, the lane of the tracking vehicle) when the distance d is less than a lane width scaled according to a distance between the tracking vehicle and the target vehicle.

Such techniques may determine when a target vehicle is in a lane of the tracking vehicle by determining whether the target vehicle is within a lane width from a lane boundary of the lane of the tracking vehicle. In some cases, such techniques may be biased toward determining that target vehicles are in the lane of the tracking vehicle. This may be advantageous because it may be safety critical to determine when a target vehicle is in the lane of the tracking vehicle.

However, in some cases, such techniques may be overly biased toward determining that target vehicles are in the lane of the tracking vehicle. To mitigate this, in some cases, a further criterion may be used to disassociate, or prevent lane associations, where a target vehicle is far enough away from a lane boundary.

For example, the systems and techniques may obtain or determine a nearest-to-camera corner point p of a two-dimensional bounding box based on a three-dimensional bounding box. Point p may be defined as p=[pₓ, p_{y}, p_{z}], where pₓ and p_{y} describe a pixel location of the point in image frame 800 (in an xy coordinate system), and p_{z} describes a distance between the tracking vehicle and the point p. The systems and techniques may determine a distance d from a lane boundary as follows:

d=min(proj(p)ₓ−lₓ^{left},lₓ^{right}−proj(p)ₓ)

For example, the distance d may be defined as the lesser of the lateral distance between a left lane boundary and a right lane boundary. Further, the systems and techniques may determine a distance threshold as follows:

$$d i s {t}_{thresh} = \frac{{l}_{w}}{2} - \frac{{v}_{w}}{2} - {δ}_{w} ,$$

where δ_{w}=0.2 m is width of collision zone and v_{w} is width of the tracking vehicle

For example, the systems and techniques may determine a distance threshold as half a lane width, less half a width of the tracking vehicle, less a safety threshold.

$$True iff d \leq d i s {t}_{thresh} * \frac{{f}_{x}}{{p}_{z}}$$

If true, the systems and techniques may change a lane association of the target vehicle from lane 0 (the lane of the tracking vehicle) to +1/−1 depending upon distance d from the lane boundary.

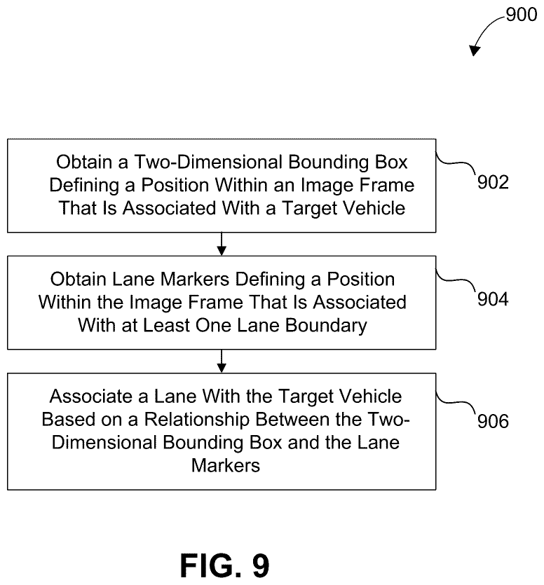

FIG. 9 is a flow diagram illustrating a process 900 for determining lane associations of target vehicles, in accordance with aspects of the present disclosure. One or more operations of process 900 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 900. The one or more operations of process 900 may be implemented as software components that are executed and run on one or more processors.

At block 902, a computing device (or one or more components thereof) may obtain a two-dimensional bounding box defining a position within an image frame that is associated with a target vehicle. For example, a computing device (or one or more components thereof) of tracking vehicle 102 may obtain bounding box 302a.

In some aspects, the bounding box may be axis aligned. For example, a bottom line of bounding box 302a may be parallel to a bottom of the image frame. In some aspects, the computing device (or one or more components thereof) may obtain a three-dimensional bounding box and project the three-dimensional bounding box onto the image frame to generate the two-dimensional bounding box. For example, bounding box 302a may be a projection of a three-dimensional bounding box onto image frame 300. In some aspects, the three-dimensional bounding box may be determined by an object-tracking. In some aspects, the three-dimensional bounding box may be determined based on image data and radio detection and ranging (RADAR) data.

In some aspects, the two-dimensional bounding box may be based on a projection of a back plane of the three-dimensional bounding box. For example, bounding box 402a may be based on a back plane of a three-dimensional bounding box. In some aspects, the two-dimensional bounding box may be based on a projection of a center plane of the three-dimensional bounding box. For example, bounding box 502a may be based on a center plane of a three-dimensional bounding box. In some aspects, the two-dimensional bounding box is determined by an object-tracking technique. For example, bounding box 602a may be determined by, or as part of an object-tracking technique.

At block 904, the computing device (or one or more components thereof) may obtain lane markers defining a position within the image frame that is associated with at least one lane boundary. For example, the computing device (or one or more components thereof) of tracking vehicle 102 may obtain lane boundary 308 and/or lane boundary 310.

At block 906, the computing device (or one or more components thereof) may associate a lane with the target vehicle based on a relationship between the two-dimensional bounding box and the lane markers. For example, the computing device (or one or more components thereof) of tracking vehicle 102 may associate lane 316 with a target vehicle associated with bounding box 302a based on the relationship between bounding box 302a and lane boundary 308 and/or the relationship between bounding box 302a and lane boundary 310.

In some aspects, the lane may be associated with the target vehicle based on a center point of a bottom edge of the two-dimensional bounding box being between lane boundaries of the lane. For example, a vehicle on which bounding box 302a is based may be associated with lane 316 based on a relationship between center point 330 and lane boundary 308 and/or based on a relationship between center point 330 and lane boundary 310.

In some aspects, the computing device (or one or more components thereof) may obtain keypoints that define positions within the image frame that are associated with wheels of the target vehicle. Further, the lane may be associated with the target vehicle based on a keypoint being between lane boundaries of the lane. For example, the computing device (or one or more components thereof) of tracking vehicle 102 may obtain keypoints 710 that define positions of wheels of a target vehicle on which bounding box 702a is based. Further, the computing device (or one or more components thereof) may associate lane 316 with the target vehicle based on a relationship between keypoints 710 and lane boundary 308 and/or a relationship between keypoints 710 and lane boundary 310. In some aspects, the lane may be associated with the target vehicle based on a closest keypoint being between lane boundaries of the lane. For example, the computing device (or one or more components thereof) may associate lane 316 with the target vehicle based on a relationship between a closest one of keypoints 710 and lane boundary 308 and/or a relationship between the closes one of keypoints 710 and lane boundary 310.

In some aspects, the computing device (or one or more components thereof) may, when a lane boundary of a pair of lane boundaries of the lane is missing from the lane markers, associate the lane with the target vehicle based on a relationship between the two-dimensional bounding box and a remaining lane boundary of the pair of lane boundary. For example, when lane boundary 816 (one of a pair of lane boundaries defining lane 822 and lane 824) is missing, the computing device (or one or more components thereof) may determine a distance between lane boundary 814 and/or lane boundary 818 and a two-dimensional bounding box based on three-dimensional bounding box 802c. The computing device (or one or more components thereof) may determine whether target vehicle 804c is associated with lane 822 based on the distance between the two-dimensional bounding box based on three-dimensional bounding box 802c and lane boundary 814. Alternatively, the computing device (or one or more components thereof) may determine whether target vehicle 804c is associated with lane 824 based on the distance between the two-dimensional bounding box based on three-dimensional bounding box 802c and lane boundary 818. In some aspects, the lane may be associated with the target vehicle based on a point of the two-dimensional bounding box being within a threshold distance from the remaining lane boundary. For example, target vehicle 804c may be associated with lane 822 based on a point of a two-dimensional bounding box based on three-dimensional bounding box 802c being within a threshold distance from lane boundary 814. In some aspects, the threshold distance may be related to a width of a lane. For example, in cases in which the point of the two-dimensional bounding box is a center point, the threshold distance may be related to half a lane width. In such cases, the computing device (or one or more components thereof) may compare the center of the target vehicle 804c with a center of lane 822.

In some aspects, the lane is associated with the target vehicle based on a relationship between a point of the two-dimensional bounding box and a first threshold distance that is related to a width of a lane and a second threshold distance that is related to a width of a tracking vehicle. For example, target vehicle 804c may be associated with lane 824 based on a point of the two-dimensional bounding box based on three-dimensional bounding box 802c being farther than half a lane-width, half the width of the tracking vehicle, and a width of a collision zone from lane boundary 814. For example, if a closest point of target vehicle 804c is farther than a width of a collision zone plus half a lane width plus half the width of the tracking vehicle from lane boundary 814, target vehicle 804c may be associated with lane 824.

In some aspects, the computing device (or one or more components thereof) may plan a path of a vehicle based on the lane associated with the target vehicle and/or control the vehicle based on the lane associated with the target vehicle. For example, tracking vehicle 102 may plan a path of tracking vehicle 102 or may control tracking vehicle 102 based on the lane associated with the target vehicle of block 906. In some aspects, tracking vehicle 102 may determine lane associations for multiple target vehicles, (e.g., target vehicle 104, target vehicle 106, and target vehicle 108). Tracking vehicle 102 may plan its path and/or control its movement (e.g., acceleration, braking, and/or steering) based on the lanes associated with the target vehicles.

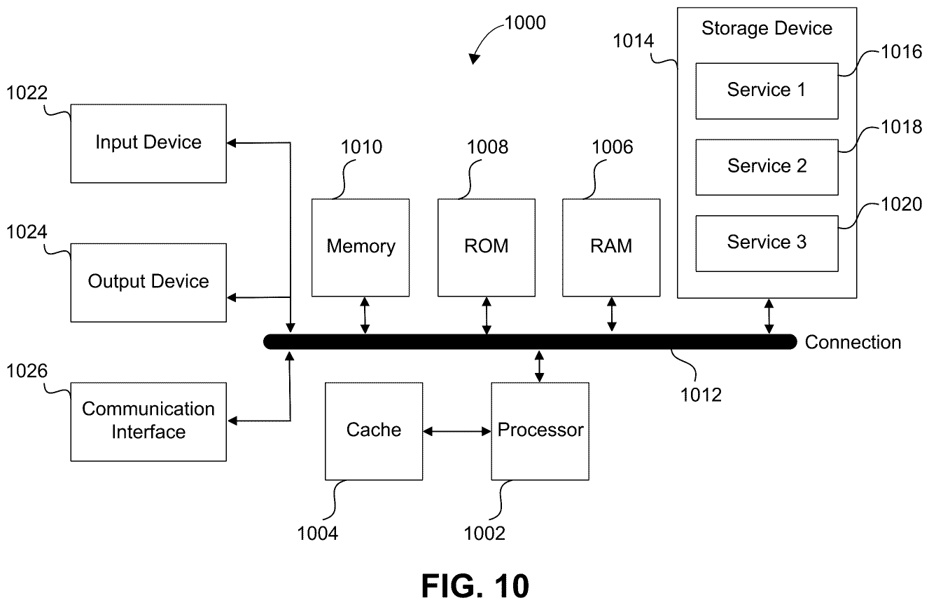

In some examples, as noted previously, the methods described herein (e.g., process 900 of FIG. 9, and/or other methods described herein) can be performed, in whole or in part, by a computing device or apparatus. In one example, one or more of the methods can be performed by a computing system of tracking vehicle 102, or by another system or device. In another example, one or more of the methods (e.g., process 900 of FIG. 9, and/or other methods described herein) can be performed, in whole or in part, by the computing-device architecture 1000 shown in FIG. 10. For instance, a computing device with the computing-device architecture 1000 shown in FIG. 10 can include, or be included in, the components of the computing system of tracking vehicle 102 and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of a computing system of tracking vehicle 102 of FIG. 1.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for determining lane associations of target vehicles, the apparatus comprising: at least one memory; and at least one processor coupled to the at least one memory and configured to: obtain a two-dimensional bounding box defining a position within an image frame that is associated with a target vehicle; obtain lane markers defining a position within the image frame that is associated with at least one lane boundary; and associate a lane with the target vehicle based on a relationship between the two-dimensional bounding box and the lane markers.
Aspect 2. The apparatus of aspect 1, wherein the two-dimensional bounding box is axis aligned.
Aspect 3. The apparatus of any one of aspects 1 or 2, wherein the at least one processor is further configured to: obtain a three-dimensional bounding box; and project the three-dimensional bounding box onto the image frame to generate the two-dimensional bounding box.
Aspect 4. The apparatus of aspect 3, wherein the three-dimensional bounding box is determined by an object-tracking technique.
Aspect 5. The apparatus of any one of aspects 3 or 4, wherein the three-dimensional bounding box is determined based on image data and radio detection and ranging (RADAR) data.
Aspect 6. The apparatus of any one of aspects 3 to 5, wherein the two-dimensional bounding box is based on a projection of a back plane of the three-dimensional bounding box.
Aspect 7. The apparatus of any one of aspects 3 to 6, wherein the two-dimensional bounding box is based on a projection of a center plane of the three-dimensional bounding box.
Aspect 8. The apparatus of any one of aspects 3 to 7, wherein the lane is associated with the target vehicle based on a center point of a bottom edge of the two-dimensional bounding box being between lane boundaries of the lane.
Aspect 9. The apparatus of any one of aspects 1 to 8, wherein the two-dimensional bounding box is determined by an object-tracking technique.
Aspect 10. The apparatus of any one of aspects 1 to 9, wherein the at least one processor is further configured to obtain keypoints that define positions within the image frame that are associated with wheels of the target vehicle and wherein the lane is associated with the target vehicle based on a keypoint being between lane boundaries of the lane.
Aspect 11. The apparatus of aspect 10, wherein the lane is associated with the target vehicle based on a closest keypoint being between lane boundaries of the lane.
Aspect 12. The apparatus of any one of aspects 1 to 11, wherein the at least one processor is further configured to, when a lane boundary of a pair of lane boundaries of the lane is missing from the lane markers, associate the lane with the target vehicle based on a relationship between the two-dimensional bounding box and a remaining lane boundary of the pair of lane boundary.
Aspect 13. The apparatus of aspect 12, wherein the lane is associated with the target vehicle based on a point of the two-dimensional bounding box being within a threshold distance from the remaining lane boundary.
Aspect 14. The apparatus of aspect 13, wherein the threshold distance is related to a width of a lane.
Aspect 15. The apparatus of any one of aspects 12 to 14, wherein the lane is associated with the target vehicle based on a relationship between a point of the two-dimensional bounding box and a first threshold distance that is related to a width of a lane and a second threshold distance that is related to a width of a tracking vehicle.
Aspect 16. The apparatus of any one of aspects 1 to 15, wherein the at least one processor is further configured to an operation, wherein the operation is at least one of: planning a path of a vehicle based on the lane associated with the target vehicle; or controlling the vehicle based on the lane associated with the target vehicle.
Aspect 17. A method for determining lane associations of target vehicles, the method comprising: obtaining a two-dimensional bounding box defining a position within an image frame that is associated with a target vehicle; obtaining lane markers defining a position within the image frame that is associated with at least one lane boundary; and associating a lane with the target vehicle based on a relationship between the two-dimensional bounding box and the lane markers.
Aspect 18. The method of aspect 17, wherein the two-dimensional bounding box is axis aligned.
Aspect 19. The method of any one of aspects 17 or 18, further comprising: obtaining a three-dimensional bounding box; and projecting the three-dimensional bounding box onto the image frame to generate the two-dimensional bounding box.
Aspect 20. The method of aspect 19, wherein the three-dimensional bounding box is determined by an object-tracking technique.
Aspect 21. The method of any one of aspects 19 or 20, wherein the three-dimensional bounding box is determined based on image data and radio detection and ranging (RADAR) data.
Aspect 22. The method of any one of aspects 19 to 21, wherein the two-dimensional bounding box is based on a projection of a back plane of the three-dimensional bounding box.
Aspect 23. The method of any one of aspects 19 to 22, wherein the two-dimensional bounding box is based on a projection of a center plane of the three-dimensional bounding box.
Aspect 24. The method of any one of aspects 19 to 23, wherein the lane is associated with the target vehicle based on a center point of a bottom edge of the two-dimensional bounding box being between lane boundaries of the lane.
Aspect 25. The method of any one of aspects 17 to 24, wherein the two-dimensional bounding box is determined by an object-tracking technique.
Aspect 26. The method of any one of aspects 17 to 25, wherein the method further comprises obtaining keypoints that define positions within the image frame that are associated with wheels of the target vehicle; and wherein the lane is associated with the target vehicle based on a keypoint being between lane boundaries of the lane.
Aspect 27. The method of aspect 26, wherein the lane is associated with the target vehicle based on a closest keypoint being between lane boundaries of the lane.
Aspect 28. The method of any one of aspects 17 to 27, further comprising, when a lane boundary of a pair of lane boundaries of the lane is missing from the lane markers, associating the lane with the target vehicle based on a relationship between the two-dimensional bounding box and a remaining lane boundary of the pair of lane boundary.
Aspect 29. The method of aspect 28, wherein the lane is associated with the target vehicle based on a point of the two-dimensional bounding box being within a threshold distance from the remaining lane boundary.
Aspect 30. The method of aspect 29, wherein the threshold distance is related to a width of a lane.
Aspect 31. The method of any one of aspects 28 to 30, wherein: the lane is associated with the target vehicle based on a relationship between a point of the two-dimensional bounding box and a first threshold distance that is related to a width of a lane and a second threshold distance that is related to a width of a tracking vehicle.
Aspect 32. The method of any one of aspects 17 to 31, further comprising an operation, wherein the operation is at least one of: planning a path of a vehicle based on the lane associated with the target vehicle; or controlling the vehicle based on the lane associated with the target vehicle.
Aspect 33. A non-transitory computer-readable storage medium having stored thereon instructions that, when executed by at least one processor, cause the at least one processor to perform operations according to any of aspects 17 to 32.
Aspect 34. An apparatus for providing virtual content for display, the apparatus comprising one or more means for perform operations according to any of aspects 17 to 33.

What is claimed is:

1. An apparatus for determining lane associations of target vehicles, the apparatus comprising:
at least one memory; and
at least one processor coupled to the at least one memory and configured to:
obtain a two-dimensional bounding box defining a position within an image frame that is associated with a target vehicle;
obtain lane markers defining a position within the image frame that is associated with at least one lane boundary; and
associate a lane with the target vehicle based on a relationship between the two-dimensional bounding box and the lane markers.

2. The apparatus of claim 1, wherein the at least one processor is further configured to:
obtain a three-dimensional bounding box; and
project the three-dimensional bounding box onto the image frame to generate the two-dimensional bounding box.

3. The apparatus of claim 2, wherein the three-dimensional bounding box is determined by an object-tracking technique.

4. The apparatus of claim 2, wherein the three-dimensional bounding box is determined based on image data and radio detection and ranging (RADAR) data.

5. The apparatus of claim 2, wherein the two-dimensional bounding box is based on a projection of a back plane of the three-dimensional bounding box.

6. The apparatus of claim 2, wherein the two-dimensional bounding box is based on a projection of a center plane of the three-dimensional bounding box.

7. The apparatus of claim 2, wherein the lane is associated with the target vehicle based on a center point of a bottom edge of the two-dimensional bounding box being between lane boundaries of the lane.

8. The apparatus of claim 1, wherein the two-dimensional bounding box is determined by an object-tracking technique.

9. The apparatus of claim 1, wherein the at least one processor is further configured to obtain keypoints that define positions within the image frame that are associated with wheels of the target vehicle and wherein the lane is associated with the target vehicle based on a keypoint being between lane boundaries of the lane.

10. The apparatus of claim 9, wherein the lane is associated with the target vehicle based on a closest keypoint being between lane boundaries of the lane.

11. The apparatus of claim 1, wherein the at least one processor is further configured to, when a lane boundary of a pair of lane boundaries of the lane is missing from the lane markers, associate the lane with the target vehicle based on a relationship between the two-dimensional bounding box and a remaining lane boundary of the pair of lane boundary.

12. The apparatus of claim 11, wherein the lane is associated with the target vehicle based on a point of the two-dimensional bounding box being within a threshold distance from the remaining lane boundary.

13. The apparatus of claim 12, wherein the threshold distance is related to a width of a lane.

14. The apparatus of claim 11, wherein the lane is associated with the target vehicle based on a relationship between a point of the two-dimensional bounding box and a first threshold distance that is related to a width of a lane and a second threshold distance that is related to a width of a tracking vehicle.

15. The apparatus of claim 1, wherein the at least one processor is further configured to an operation, wherein the operation is at least one of:
planning a path of a vehicle based on the lane associated with the target vehicle; or
controlling the vehicle based on the lane associated with the target vehicle.

16. A method for determining lane associations of target vehicles, the method comprising:
obtaining a two-dimensional bounding box defining a position within an image frame that is associated with a target vehicle;
obtaining lane markers defining a position within the image frame that is associated with at least one lane boundary; and
associating a lane with the target vehicle based on a relationship between the two-dimensional bounding box and the lane markers.

17. The method of claim 16, further comprising:
obtaining a three-dimensional bounding box; and
projecting the three-dimensional bounding box onto the image frame to generate the two-dimensional bounding box.

18. The method of claim 17, wherein the three-dimensional bounding box is determined by an object-tracking technique.

19. The method of claim 17, wherein the three-dimensional bounding box is determined based on image data and radio detection and ranging (RADAR) data.

20. The method of claim 17, wherein the two-dimensional bounding box is based on a projection of a back plane of the three-dimensional bounding box.

21. The method of claim 17, wherein the two-dimensional bounding box is based on a projection of a center plane of the three-dimensional bounding box.

22. The method of claim 17, wherein the lane is associated with the target vehicle based on a center point of a bottom edge of the two-dimensional bounding box being between lane boundaries of the lane.

23. The method of claim 16, wherein the two-dimensional bounding box is determined by an object-tracking technique.

24. The method of claim 16, wherein the method further comprises obtaining keypoints that define positions within the image frame that are associated with wheels of the target vehicle; and wherein the lane is associated with the target vehicle based on a keypoint being between lane boundaries of the lane.

25. The method of claim 24, wherein the lane is associated with the target vehicle based on a closest keypoint being between lane boundaries of the lane.

26. The method of claim 16, further comprising, when a lane boundary of a pair of lane boundaries of the lane is missing from the lane markers, associating the lane with the target vehicle based on a relationship between the two-dimensional bounding box and a remaining lane boundary of the pair of lane boundary.

27. The method of claim 26, wherein the lane is associated with the target vehicle based on a point of the two-dimensional bounding box being within a threshold distance from the remaining lane boundary.

28. The method of claim 27, wherein the threshold distance is related to a width of a lane.

29. The method of claim 26, wherein: the lane is associated with the target vehicle based on a relationship between a point of the two-dimensional bounding box and a first threshold distance that is related to a width of a lane and a second threshold distance that is related to a width of a tracking vehicle.

30. The method of claim 16, further comprising an operation, wherein the operation is at least one of:
planning a path of a vehicle based on the lane associated with the target vehicle; or
controlling the vehicle based on the lane associated with the target vehicle.
